(19) United States
(12) Patent Application Publication
(10) Pub. No.: US 2005/0030944 A1
(43) Pub. Date: Feb. 10, 2005

(54) Method and apparatus for reducing packet size employing payload header suppression (PHS)

(75) Inventors: David B. Lazarus, Elkins Park, PA (US); Beverly Levis, Hatboro, PA (US)

Correspondence Address: VOLPE AND KOENIG, P.C.;DEPT. MOT, UNITED PLAZA, SUITE 1600, 30 SOUTH 17TH STREET, PHILADELPHIA, PA, 19103, US

(73) Assignee: General Instrument Corporation, Horsham, PA (US)

(21) Appl. No.: 10/446,098

(22) Filed: May 27, 2003

(51) Int. Cl. H04L 12/56

(52) U.S. Cl. 370/389

(57) ABSTRACT

Method and apparatus for adjusting payload header suppression (PHS) at the sender by the receiver based on the receiver's inspection of received packets. As the contents of the packets change, and payload header suppression becomes ineffective, the receiver detects this case and coordinates a switch to an effective payload header suppression rule.

### FIELD OF THE INVENTION

The present invention relates to cable modem telephony service. More particularly, the invention relates to reducing packet size in data over cable system interface specifications (DOCSIS) Cable Modem (CM) support telephony and other streaming media.

### BACKGROUND

The key cost of cable modem telephony service is the required amount of bandwidth. DOCSIS 1.1 provides a mechanism for reducing packet size employing payload header suppression (PHS). PacketCable® (a registered trademark of CableLabs, a standards setting body) has promulgated a dynamic quality of service (DQoS) specification which defines how upstream PHS is to be performed but fails to define a workable scheme for handling most of the downstream fields. The present invention developed as a result of previous failures to compress downstream voice data. Although a number of efforts have been brought to bear to provide schemes for upstream compression, downstream compression has been generally overlooked because it is assumed to have a lower per byte cost. In addition, the algorithm disclosed herein can be utilized where voice traffic from a stand-alone multi-media terminal adapter (SMTA) is transported by a cable modem (CM) or by an embedded MTA (eMTA) to a cable modem termination service (CMTS).

### SUMMARY

The present invention reduces required bandwidth and hence lowers costs by dynamically adding and modifying Payload Header Suppression rules based upon the examination of received messages and employing a combination of speculative and a priori based PHS rules to reduce bandwidth.

### BRIEF DESCRIPTION OF THE FIGURES

The present invention will be understood from a consideration of the detailed description and drawings in which like elements are designated by like numerals and, wherein:

FIG. 1 is a flow diagram showing classification logic employed by a cable modem termination system (CMTS).

FIG. 2 shows an adaptation logic flow diagram employed by an embedded multi-media terminal adapter (eMTA).

FIG. 3 is a simplified block diagram showing an implementation of the present invention in a cable modem (CM).

FIG. 4 is a simplified block diagram showing an implementation of the present invention in a cable modem termination system (CMTS).

### DETAILED DESCRIPTION OF THE INVENTION AND THE PREFERRED EMBODIMENTS THEREOF

Many of the fields in the packet headers of downstream traffic are difficult to compress out even when employing the DOCSIS Payload Header Suppression (PHS) scheme. The DOCSIS PHS scheme requires that the data value to be suppressed must be supplied when a PHS rule is defined. However, because downstream traffic is generated by external devices, the value of some of the fields may not be known a priori. As an example, the synchronization source (SSRC) field of a user datagram protocol (UDP) encapsulated real time protocol (RTP) packet of a typical telephony application is selected by the far end device and sent to the modem or multi-media terminal adapter (MTA). The value was not known when the service flow for that traffic was created.

Other data fields may vary over time but rarely change such as, for example, the two high bytes of the real time protocol (RTP) Timestamp. The present invention provides a scheme for compression of these more difficult fields. In one basic form of the present invention, a given downstream service flow is provided with multiple classifiers, each with a PHS rule. The first PHS rule, hereinafter known as the a priori rule, compresses only fields with values that are known a priori. Other PHS rules, hereinafter known as speculative rules, remove both those fields with values that are known a priori and fields with values that are discovered by inspection of packets that have already arrived. Since the speculative rules remove more fields, packets that use them are shorter and therefore require less bandwidth. Bandwidth savings allow more cable modem (CM) and MTA units to be supported within the same infrastructure.

When a packet arrives at the CM, it is examined. If the CMTS sent the packet using the a priori rule or if no PHS rule was used, a speculative PHS rule and classifier are added to the service flow using a dynamic service change (DSC) operation. This rule enables fields that could not be known a priori to be removed.

PHS rules (with corresponding classifiers) are set up such that the speculative rule will be used if it matches the downstream data. The DOCSIS 1.1 “verify” field can be used in this classification. If the CMTS cannot match the downstream data with a speculative rule, then the a priori rule can be used. If the a priori rule does not match the data or the CMTS cannot default to it, no PHS rule will be used. Generally, it is important for the a priori rule to match almost all of the data and for the MTA to adjust quickly when the data changes.

The DOCSIS 1.1 specification does not specify what should be done when a packet matches a classifier but fails a verification test. As a result, the packet can either be:
a) placed on the primary (default) downstream;
b) placed on the service without PHS; or
c) undergo continuing classification using lower precedence classifiers.

The third option, (c), is the most useful since it allows an a priori rule to serve as a fallback PHS rule and makes it easier to have multiple speculative rules.

Initially, downstream flow is set up employing only the a priori rule. As the first few packets arrive, they are employed to develop a speculative rule. Successive packets received thereafter are reduced in size by employing a speculative rule. When a packet arrives that does not employ the speculative rule, it is utilized to build a new speculative rule.

When a speculative PHS rule has not been used for a while, it should be removed. Ideally, this is accomplished by using the same DSC that is used to add a new speculative rule. There is a cost to adding a new speculative rule because the DSC requires additional bandwidth. As a result, the use of this technique is preferably limited to situations where the resulting savings compensates for the overhead of the DSC operations. It is also possible to only add a speculative rule after observing several packets with identical values.

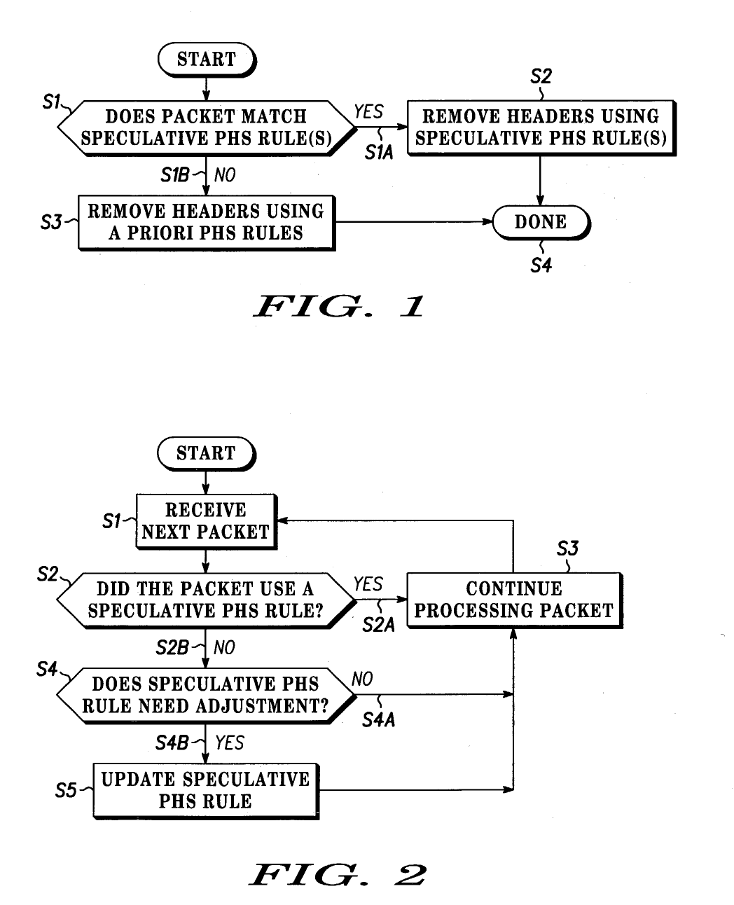

Making reference to FIG. 1, CMTS classification logic in accordance with the previous rules is shown wherein after the start of classification, an arriving packet is examined at step S1 to determine if it matches a speculative PHS rule (or rules). If the answer is yes, the program branches at S1A to step S2 wherein header fields identified by the first (or best) matching speculative PHS rule are removed.

In the event that a packet does not match any speculative PHS rule(s), the routine branches at S1B whereupon, at step S3, header fields of the packet matching an a priori PHS rule are suppressed. It should be understood that suppressed headers are restored at the receiving end.

Upon completion of either step S2 or S3, the classification procedure is completed, at S4, and the examined packet is passed to the next stage in readiness for downstream delivery.

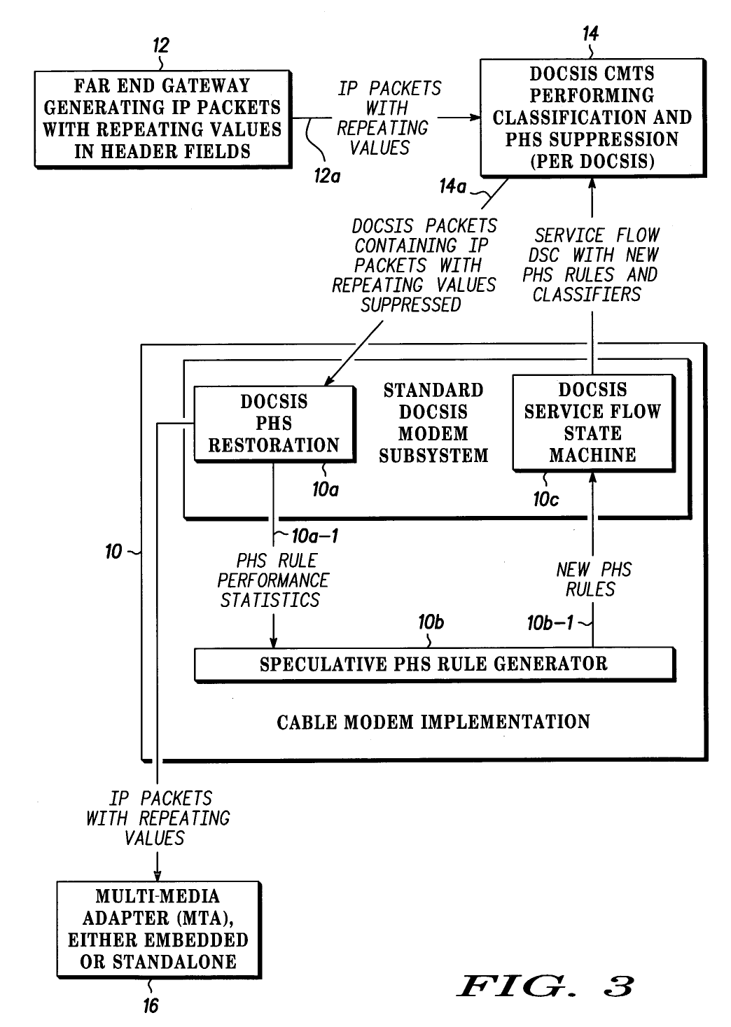

FIG. 2 shows the adaptation logic employed by an eMTA in accordance with the rules set forth above. The examination of received data packets and the generation of the speculative PHS rules could alternatively be performed within the CMTS and the PHS rule could be added via a CMTS initiated DSC.

After start of the adaptation program is initiated, the next packet is received, at step S1.

At step S2, a determination is made as to whether the packet employs a speculative PHS rule. If the answer is yes, the routine branches at S2A to step S3 wherein packet processing continues. Step S3 may, for example, restore the suppressed fields and deliver the packet to the audio playout subsystem. In the event that the packet does not employ a speculative PHS rule, the routine branches at S2B to step S4 to determine if the speculative PHS rule requires adjustment. If no adjustment is required, the routine branches at S4A returning to step S3 to continue packet processing which may, for example, restore the suppressed fields and deliver the packet to a suitable audio playout subsystem, not shown for purposes of simplicity and typically forming part of a multi-media adapter (MTA).

If the speculative PHS rule needs adjustment, the routine branches at S4B to step S5 for updating the speculative PHS rule, thereafter returning to step S3 where processing of the packet continues. As an example, if the SSRC value has changed, DOCSIS DSC operations are used to add a new PHS rule that is similar to the old one, except that it has a new SSRC value. This new PHS rule requires a new classifier and has a more significant rule precedence.

A downstream voice packet may contain a variety of different header fields. The values of some header fields are constant and are known ahead of time and these fields can be included in the a priori PHS rule. Other header field values do not change over an extended period but are not known ahead of time. These field values can be discovered after several downstream voice packets have been received and may then be included in a speculative PHS rule. The remaining header fields have constantly changing values and cannot be PHS suppressed.

The a priori PHS rule can include constant fields such as the Ethernet frame type, the Internet Protocol (IP) version and header length fields and the IP protocol. The destination IP address and destination port are the local IP address and port of the MTA constructing the PHS rule and are clearly known at call set up time and are therefore candidates for the a priori rule.

The Type of Service (TOS) field in the IP header may have the same value in each downstream voice packet of a phone call. However, this value may be configurable and hence no assumptions can be made about its value ahead of time. However, the value can be discovered after receiving the first downstream packet and included in a speculative PHS rule.

Since the payload length of a voice packet is predetermined by the coder/decoder (CODEC), the IP total length field generally remains the same for each downstream voice packet on a service flow. However, since multiple CODECs may be negotiated and the sending side may choose from several different CODEC and packetization options, the actual packet size may not be known at the receiving side until one or more packets are received. Other issues such as padding bytes can add additional variability. Once length is discovered by observing the first few packets, it may be included in the speculative rule. Over the life of the connection, the CODEC and/or the packetization period may change, which will result in the changing or addition of a new speculative PHS rule.

The identification, flags and fragment offset fields of the IP header control fragmentation and reassembly. When fragmentation takes place, these fields are constantly changing. However, since the voice packets are fixed in length and relatively small, fragmentation is generally not necessary. If sufficient information is known about the network between the CMTS and the MTA to assume that fragmentation will not take place on downstream voice packets, these fields take on “don't care” values that can be suppressed out by a speculative rule.

The time to live (TTL) value in an IP header may vary over the life of the packet. However, if the network path that the downstream voice packets follow remains relatively constant, it is a good probability that each arriving packet at the MTA will have the same TTL value, making this value a candidate for a speculative rule, which value can be determined from the first several packets of the received flow. Those occasional packets that have a higher or lower TTL value are handled by the a priori rule.

When the IP header checksum field is in use, it has a different value in each voice packet and is thus not suppressible. However, if the checksum field is not used and takes on a constant value of zero, this field can be suppressed by a speculative rule. The MTA can determine from the first few downstream voice packets that arrive whether or not the IP header checksum field is in use.

The source IP address is not likely to change during the life of a connection in current call flows. Nevertheless, the option of changing the remote end point IP address remains. This capability is useful in call waiting or switching to a conferencing bridge making the source IP address field in the IP header a candidate for either the a priori PHS rule or a speculative rule. The source address may not be known when the connection is first established.

In the user datagram protocol (UDP) header, the UDP source port value may not be known when the connection is first established. However, once it is known, it is not likely to change nor to change frequently over the life of the connection. UDP source port is optional and should have a value of zero when it is not used. Once bandwith is committed, this value can be discovered from the first few packets received from the source and can be included as a speculative rule.

Since payload length of a voice packet is predetermined by the CODEC, the UDP message length field generally remains the same for each downstream voice packet on a service flow. However, multiple CODECs may be negotiated and the sending side may choose from several different CODECs and packetization options, and the actual packet size may not be known at the receiving side until one or more packets are received. Other issues such as padding bytes can be included in a speculative rule. Over the life of the connection, the CODEC and/or packetization period may change with the result being a changing or addition of a new speculative PHS rule.

If the UDP checksum field is in use, it cannot be suppressed because it will have a different value in each downstream voice packet, however, if the checksum field is not used and takes on a constant value of zero, it can be suppressed in the speculative rule. The MTA can determine from the first few downstream voice packets that arrive whether or not the UDP checksum field is in use.

The first byte of the real time protocol (RTP) header is broken into fields of bits that represent the RTP version, the padding bit, the extension bit and the control source (CSRC) count. These values may vary from one phone call to another but typically remain constant within the same phone call and, once the value for this field is discovered from the first few received packets, it can be included in the speculative rule. If the RTP source is mixing contributing sources and it includes CSRC fields in the RTP extended header, the CSRC may change occasionally, necessitating a changing or addition of a new speculative PHS rule. As an example, an extended header containing a CSRC list may be suppressed.

The second byte of the RTP header contains a marker bit and the payload type. Payload type usually remains constant over the life of the call. However, the marker bit may be used to mark significant events such as frame boundaries, causing some packets to have the marker bits set while other packets will not. If the significant event markers occur infrequently, it is worthwhile to suppress this field. The few packets that arrive with the significant event marker set will fall through the speculative rules to the a priori rule, however, if the significant event markers occur frequently, the field should not be suppressed.

The RTP sequence number field comprises two bytes in the RTP header. The sequence numbers are incremented by one for each voice packet transmitted and the least significant byte (LSB) of the field constantly changes. The value of the most significant byte (MSB) remains constant until the LSB rolls over, which happens every 256 packets. However, the overhead of creating a new speculative rule is prohibitive and this field should not be removed by PHS.

The RTP timestamp field comprises four (4) bytes in the RTP header. As with the sequence number, the least significant bytes change more frequently than the most significant bytes as the timestamp increases and it may be feasible to include the top two (2) most significant bytes of the timestamp in a speculative rule. A new speculative rule will be needed each time the high two bytes change.

The RTP synchronization source (SSRC) identifier field in the RTP header contains a randomly selected identifier that remains constant over the life of the flow. Although its value is not known ahead of time, it can be assumed to remain constant once it is known and is thus a good candidate to be included in a speculative rule.

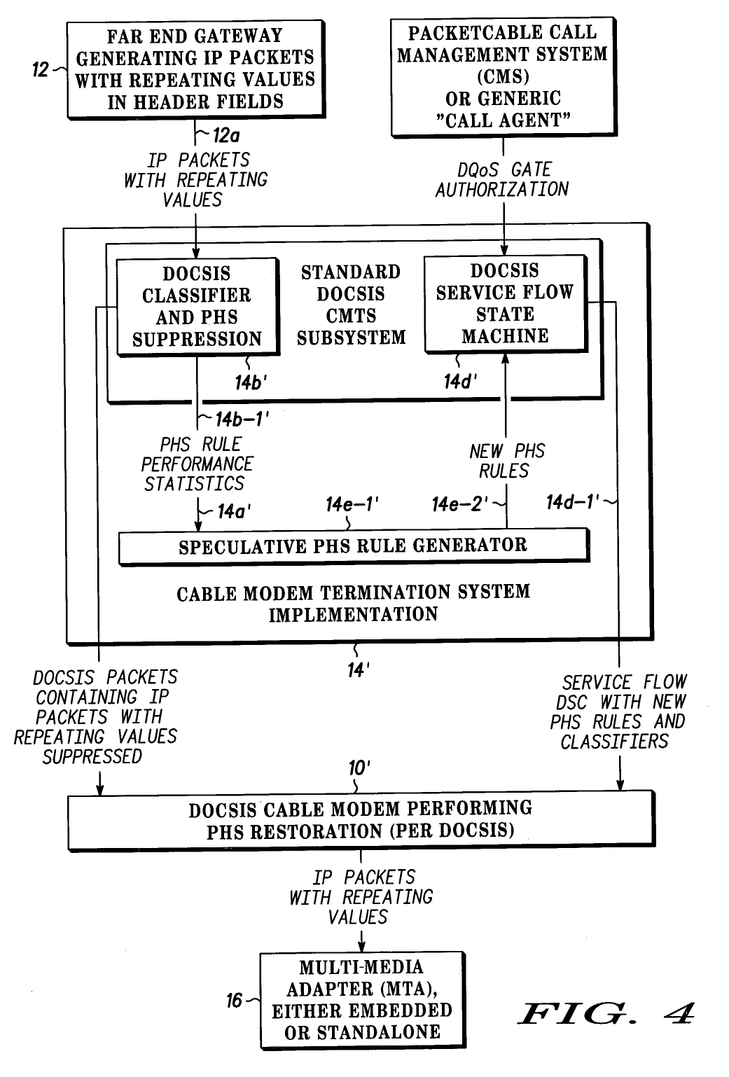

When the present invention is implemented in a DOCSIS Cable Modem (CM), the basic CM functions are extended. FIG. 3 shows a cable modem CM 10 which, as in any DOCSIS CM that supports PHS, downstream voice packets 14a arrive at the CM10 from the far end gateway 12 via the CMTS14 through channel 12a. The packets are processed by the CM10 and forwarded to a Multimedia Terminal Adapter (MTA)16 for conversion to voice. The MTA 16 may be a separate unit or it may be embedded in CM10. The CM10 and CMTS14 share Service Flows that have Classifiers and PHS rules. The CMTS uses the classifier to assign traffic which to a service flow the PHS rules to suppress redundant header fields. When CM10 receives the downstream packets 14a, it uses the PHS rule to restore the suppressed fields, at 10a.

The PacketCable DQoS specification further defines the use of PHS in a PacketCable connection. The use of PHS is an option in DQoS and DOCSIS. At the beginning of a telephone connection (or similar function) the service flows, classifiers and PHS rules are established. The PacketCable DQoS specification defines the behavior of the Service Flows. Currently, the use of PHS is not fully defined in DQoS.

In the present invention, new functions are added to a DOCSIS CM existing design (or product). Each arriving packet on a downstream service flow using a connection is examined. The PHS index is used to identify the PHS rule and Service Flow and the performance of the PHS rules are determined. Based on performance, new speculative PHS rules are added.

The process of adding the PHS rule is initiated by one of the aforementioned new functions shown in FIGS. 1 and 2 and described above in detail. The standard CM packet processing is extended to capture the PHS performance statistics 10a-1 which are delivered to a speculative rules generator 10b. New PHS rules, 10b-1, generated at 10b are provided to the DOCSIS service flow state machine 10c. The service flow DSC together with new PHS rules and classifiers are delivered to CMTS14, from the DOCSIS Service Flow State Machine 10c forming part of the standard DOCSIS Modem subsystem.

When the present invention is implemented in a DOCSIS Cable Modem Termination System (CMTS), the basic CMTS functions are extended. FIG. 4 shows a CMTS14′ (modified relative to the CMTS14 shown in FIG. 3) to provide two new functions of the present invention. At CMTS 14′, in which, as in any DOCSIS CMTS that supports PHS, downstream voice packets 12a arrive from the far end gateway 12 via the IP network. The voice packets are processed by the CMTS 14′ and transmitted into the cable plant to be received by the CM10′ which differs from the CM10 in FIG. 3 by the omission of new functions of two present inventions and transfer of these functions to CMTS 14′. The CM10′ and CMTS 14′ share Service Flows 14d-1′ that have Classifiers and PHS rules. CMTS 14′ uses the classifier to assign traffic to a service flow and the PHS rules to suppress redundant header fields. When the CM10′ receives the downstream packets, it uses the PHS rule to restore the suppressed fields.

In the present invention, new functions are added to DOCSIS CMTS existing design (or product.) Before transmitting each packet on a downstream service flow 14a′, the performance of the PHS rules is examined. Based on this performance, new speculative PHS rules are added.

The process of adding the PHS rule is initiated by one of the aforementioned new functions shown in FIGS. 1 and 2 described above in detail. The standard CMTS packet processing 14b′ is extended to capture the PHS performance statistics, 14b-1′ and the standard CMTS service flow state machine is extended to allow for the speculative PHS rule generator 14c-1′ to initiate new PHS rules 14c-2′. The rest of the process is standard DOCSIS.

There are no other CM requirements except to conform to DOCSIS and supports PHS.

1. A method for payload header suppression (PHS) in a service flow established in a communication system, comprising:
a) examining received packets in the service flow; and
b) developing a speculative PHS rule to suppress at least one field having a value which is repeated in successive packets and which has not been suppressed by a priori PHS rules.

2. The method of claim 1 further comprising:
c) receiving packets with suppressed fields;
d) detecting the suppressed fields in said packets; and
e) restoring the suppressed fields.

3. The method of claim 2 further comprising:
f) repeating steps (a) through (e) during a life of a connection.

4. The method of claim 1 further comprising:
c) comparing a received packet with an a priori rule when the received packet examined at step (a) does not match a speculative rule; and
d) suppressing a header field which matches an a priori rule.

5. The method of claim 1 further comprising:
c) comparing a received packet with an a priori rule; and
d) creating a new speculative rule when the headers of a packet do not match any priority speculative rule.

6. The method of claim 1 further comprising:
c) comparing a received packet with an a priori rule; and
d) revising a speculative rule when the headers of a packet do not match any of the speculative rules.

7. A method for packet header suppression (PHS) in a communication system including:
a) receiving a payload of packets;
b) comparing packet headers with a group of a priori rules; and
c) developing a speculative rule for use in header suppression of subsequent packets when the received packet does not match any of the a priori rules.

8. The method of claim 7 wherein step (a) includes receiving a packet and an accompanying a priori rule for header suppression.

9. The method of claim 5 further comprising:
d) comparing headers of subsequent packets with the speculative rule; and
e) suppressing the header fields that match the speculative rule.

10. The method of claim 7 further comprising:
d) comparing headers of subsequent packets with the speculative rule of step (c) and modifying the speculative rule of step (c) when no headers match the speculative rule of step (c).

11. The method of claim 7 further comprising:
d) comparing headers of subsequent packets with the speculative rule of step (c) and dropping the speculative rule of step (c) when no headers match the speculative rule of step (c).

12. Apparatus for payload header suppression (PHS) of a service flow containing packets in a communication system, comprising:
means for receiving said packets;
means for comparing each received packet with given speculative rules; and
means for suppressing each header field which matches a speculative rule.

13. The apparatus of claim 12 further comprising:
means for comparing the received packet with an a priori rule when the received packet examined does not match a speculative rule; and
means for suppressing a header field which matches an a priori rule.

14. The apparatus of claim 12 further comprising:
means for creating a new speculative rule when a packet header does not match any of the speculative rules.

15. The apparatus of claim 12 further comprising:
means for revising an existing speculative rule when the headers of a packet do not match any of the existing speculative rules.

16. The apparatus of claim 12 further comprising means for detaching packets having headers with suppressed fields, and means for restoring the suppressed fields

17. Apparatus for packet header suppression (PHS) in a communications system having a service flow containing packets, including:
means for receiving said packets;
means for comparing headers of said packets with a group of a priori rules; and
means for developing a speculative rule for use in suppression of header fields of subsequent packets when the comparing means indicates that received packet does not match the a priori rules.

18. The apparatus of claim 17 further comprising:
second means for comparing headers of subsequent packets with the speculative rule provided by said means for developing a speculative rule; and
means for suppressing those header fields that match the speculative rule.

19. The apparatus of claim 17 further comprising:
means for modifying the speculative rule when the second means indicates that no headers match the speculative rule.

20. The apparatus of claim 17 further comprising:
means for dropping the speculative rule when the second means indicates that no headers match the speculative rule.

21. The apparatus of claim 17 wherein packets are accompanied by an a priori rule for payload header suppression (PHS).

22. A method utilizing payload header suppression (PHS) in a wireless communication system wherein payload headers are suppressed based upon an initial set of rules, comprising;
a) establishing a downstream service flow;
b) examining received packets in the downstream flow;
c) adding or modifying speculative PHS rules for the service flow to suppress fields of packets with repeating values that are not suppressed.

23. The method of claim 22 further comprising:
d) identifying received packets having suppressed fields; and
e) restoring the suppressed fields.

24. The method of claim 23 further comprising:
repeating steps (a) through (e) throughout a service flow.
